(19) United States
(12) Patent Application Publication
(10) Pub. No.: US 2024/0315217 A1
(43) Pub. Date: Sep. 26, 2024

(54) SMART AQUACULTURE GROWTH AND HEALTH MONITORING SYSTEM

(71) Applicant: RYNAN TECHNOLOGIES PTE. LTD., Singapore (SG)

(72) Inventors: HOANG LUOM PHAM, Vinh Long Province (VN); QUOC TOAN TRAN, Tra Vinh Province (VN); THANH TRIEU LE, Kien Giang Province (VN); QUOC CUONG HONG, Tra Vinh City (VN); HOANG PHUONG SON, Tra Vinh Province (VN); MY T NGUYEN, Tra Vinh City (VN); NGOC TRANG DONG, Tra Vinh Province (VN); DANH V HO, Tra Vinh Province (VN); MINH TRUONG DOAN, Tra Vinh Province (VN); TAN DAT BUI, Tra Vinh Province (VN)

(73) Assignee: RYNAN TECHNOLOGIES PTE. LTD., Singapore (SG)

(21) Appl. No.: 18/043,811

(22) PCT Filed: Nov. 24, 2020
(86) PCT No.: PCT/IB2020/061108

§ 371 Date: Mar. 2, 2023

(51) Int. Cl. A01K 61/90; A01K 61/59; A01K 61/80; A01K 63/04

(52) U.S. Cl. CPC A01K 61/90; A01K 61/59; A01K 61/80; A01K 63/04

(57) ABSTRACT

There is provided a smart aquaculture growth and health monitoring system and method for monitoring the growth and health of an aquatic species present in an aquaculture growth habitat. The system comprises a georeferenced location beacon of the growth habitat, a sample container to sample water and aquatic species from the growth habitat and being configured to permit an electronic device having camera such as a smart phone to acquire digital visual data on said sample, a processor is communicatively linkable to the electronic device and optionally to a communications network, the processor being operable to receive the digital visual data; determine, based on the digital visual data, growth and/or health parameters of the aquatic species in the sample; and to retransmit data on the growth and/or health parameters of the aquatic species back to the electronic device.

### CROSS-REFERENCE TO RELATED APPLICATIONS

None

### FIELD

The present technology relates to the aquaculture of aquatic species such as fish and shellfish, such as shrimp, and more specifically to a smart aquaculture water quality, growth and health monitoring system for monitoring growth progress and health of aquatic species over time and for establishing traceability data, as well as methods of operating the system.

### BACKGROUND

Aquaculture of fish and shellfish is the fastest growing animal-food producing sector. It now provides over half of all fish and shellfish species that are consumed. Intensive aquaculture techniques have nevertheless led to suboptimal growth and health of aquatic species including the emergence of various diseases. Current estimates suggest between ⅓^{rd} to ½ of farmed fish and shrimps are lost to poor health management before they reach marketable harvest size (Tan et al., 2006).

In many parts of the world fish or shellfish aquaculture takes place in enclosures such as water basins. In the case of shrimp aquacultures these basins usually artificial basins and are called shrimp grow out ponds. The ponds are filled with water from a nearby water body, seeded with shrimp larvae which are fed and raised to grow to marketable size. In intensive and super-intensive shrimp farming, the shrimp are regularly fed so as to optimize rapid growth. In about three to four months shrimp such as Litopeneaus vannamei are usually ready to be harvested. In such operations, feed material generally accounts for over half of the total production cost. Some aquacultures also involve various disease control measures such as the use of sanitizing chemicals antibiotics. Unfortunately, harvests are often ravaged by disease.

Indeed, shrimp yield and size are often negatively impacted by disease, overfeeding, underfeeding, low dissolved oxygen levels, pollution, pH deviations, water salinity and water temperature. If the shrimp harvest is deficient in yield, the shrimp farm may experience financial losses due to the cost of the investment in feed, medications, shrimp larvae, energy and human resources. In the best case, shrimp ponds will generate a healthy margin. In reality, margins are difficult to predict because of the risks involved.

For example, overfeeding quickly impacts the water quality causing disease outbreaks and high rate of shrimp mortality or slow growth. Conversely, underfeeding delays the growth of shrimp. Proper feed management and proper health and growth monitoring remain a challenge dependent on the shrimp farmer skill, experience and sometimes luck.

One factor to consider is that daily feed requirements continuously vary and are strongly dependent on the shrimp biomass present in the grow out ponds at various stages in time (i.e., shrimp density and average shrimp body weight), fluctuation of water quality (i.e., dissolved oxygen, salinity, pH, turbidity, pollutants and water temperature) and weather conditions (i.e., rainy, sunny and windy). However, continuously monitoring the growth and health of aquatic species adjusting feed requirements based on these parameters is beyond the reach of most, if not all, shrimp farms.

Some grow out pond operations systematically use antibiotics or sanitizing chemicals to prevent disease. Not only is this expensive and wasteful if the shrimp is healthy and does not require it, but it may also foster the development of antibiotic resistant bacteria and untreatable disease proliferation.

It is known that most shrimp diseases occur within their digestive tract known as their hepato-pancreatic tract. Because the shell of juvenile shrimp is slightly transparent, a diseased shrimp will display visual clues attributable to the differences in the appearance of their hepato-pancreatic tract. Also, many shrimp diseases are detectable by visual clues such as color, size, shape, movement, etc.

In another aspect, the traceability of aquaculture harvests is becoming increasingly important in the sale of such harvests in various countries due to tighter legislation on proof of origin and growth conditions and consumer demand for real traceability. Traceability means that the provenance and growth conditions of the aquatic species must be established from its origin, for example from a shrimp grow out pond at larvae stage all the way to the point of sale of mature shrimp anywhere in the world. Full traceability means that consumers and retailers may trace back the provenance and aquaculture conditions such as location of the grow out pond, feed manufacturer, production location, feed ingredients, medications used, if any, yield of harvest including size of aquatic species over time, harvest date, expiry date, feeding times, feeding conditions, water quality conditions, harvest storage conditions and distribution routes.

In one aspect of traceability, efforts have been made to develop systems for automatic feeding of shrimp based on various parameters such as age of the shrimp, water conditions, shrimp numbers and so on and to record the feeding data. Automatic shrimp feeders are set to turn on and broadcast metered amounts of aquafeed at preset intervals.

For example, a smart feeding system is presented in co-pending PCT/IB2020/057416 by the same applicant. Such system is reliable and uses various water sensors to determine optimal feed rates via various feedback mechanisms. The system also provides data for traceability of the grow operations especially as to feed sources, rates and water quality. However, such system does not comprise the present means to actively monitor the health and growth curve of the aquatic species.

It is also known to derive the identity and weight of a sample of aquatic species by using computerized image analysis. This is shown, for example, in WO 2019/210421. There is described an aquatic species weight determination method using image analysis by comparing images of samples with known images of aquatic species and known images corresponding to various weights of those species and using a computer to provide an estimated species identity and weight output. The scale and focal distance of the camera is set by placing samples in a known container size or placing a scaled object or design next to the samples. However, such systems do not provide data on the health of the species and do not provide traceability data over time or provide georeferenced positioning of the aquaculture for traceability.

Indeed, integrating georeferenced positioning data of the grow out pond as well as regular growth and health data on the aquaculture species such as shrimp, will provide the required information to establish a suitable factual basis for traceability.

### SUMMARY

It is an object of the present technology to ameliorate at least some of the inconveniences present in the prior art. One or more embodiments of the present technology may provide and/or broaden the scope of approaches to and/or methods of achieving the aims and objects of the present technology.

Developer(s) of the present technology have appreciated that growth curves, health parameters and traceability of aquatic species farms can be efficiently collected and analyzed to provide ongoing monitoring of harvest characteristics and requirements.

Thus, one or more embodiments of the present technology are directed to a smart aquaculture growth, health and traceability monitoring system.

In accordance with a broad aspect of the present technology, there is provided a smart aquaculture growth, health and traceability monitoring system.

In some embodiments, the present technology includes providing a geo-referencing tag such as an RFID emitter, a bar code or QR code display at the specific aquaculture site providing a unique identifier of the aquaculture farm location size or other parameters, said unique identifier being detectable by a mobile phone such as a mobile phone having a camera or an RFID detector.

In some embodiments, the technology features a sample container adapted to receive and hold a random sample of aquatic species periodically extracted from the aquaculture farm along with a certain quantity of water, the container having apertures on the sides thereof at a given vertical height to expel by gravity excess water and thereby establish a given flat water level with the aquatic species such as shrimp being maintained in the area limited by the container bottom and sides and the water level. The container is generally tubular, bucket shaped, square or rounded, and open at one end.

In some embodiments, the container is provided with a removable top or grid constituting a resting surface having an aperture suitable for resting thereon a mobile device with a camera and providing the camera a line of sight into the container, the mobile device being communicatively coupled to software to receive image data of the aquatic species sample, said image data being transmitted to a network and analyzed by a processor to provide growth and health data on said aquatic species. The network is adapted to relay information back to the mobile phone application and display growth and health characteristics over time and provide recommendations to the user.

In one or more embodiments, the network also receives additional data, from a set of sensors installed at the aquaculture farm aqueous body, the sensors providing water quality parameters to as to provide additional data to determine, based on the sensor data and the growth and health data of the aquatic species appropriate measures for next steps such as water quality adjustments, quantity of aquafeed to provide to the aquaculture, or even medications or additives to be added to the aquaculture basin.

In some embodiments, the network is also associated and linked to the smart feeder system as disclosed and described in co-pending PCT/IB2020/057416 by the same applicant.

Thus, in one or more embodiments an array of sensors located in the aquaculture aqueous body comprising at least one of: a temperature sensor, a pH sensor, a dissolved oxygen (DO) sensor, a nitrite sensor (NO₂⁻) sensor, an ammonia sensor (NH₃), a scale sensor, a turbidity sensor, and a salinity sensor. All data is integrated and submitted to an algorithm for displaying growth and health data and for displaying recommended courses of action especially if the growth and health of the aquatic species is not following an optimal pattern.

In one or more embodiments of the smart aquaculture growth, health and traceability monitoring system, the processor linked to the network has access to a set of machine learning algorithms (MLAs) having been trained to determine the growth patterns and health parameters of the aquatic species being grown by virtue of image analysis and comparison. The set of machine learning algorithms (MLAs) having been trained to determine the expected growth pattern over time and health parameters of the aquatic species being grown and having been trained to provide a recommended course of action in response to the measured growth and health parameters. Recommended courses of action can range from feed variations to water treatment chemicals to additives such as antivirals or antibiotics or probiotics.

In one or more embodiments, the health status of juvenile shrimp is monitored by image comparison of the shrimp, including its visible digestive tract and color of shrimp external and internal organs (hepatopancreas) to detect such diseases, such as bacterial, viral, fungal, protozoal or non-infectious diseases such as muscle necrosis, incomplete molting, bent tail/cramp shrimp, red disease or soft shell syndrome. Examples of detectable diseases are monodon baculovirus infections, such as hepato-pancreatic parvo-like virus (HPV), lymphoid organ parvo-like virus (LOPV), systemic ectodermal and endodermal baculovirus (SEEB), dsDNA virus, togavirus, white spot syndrome virus (WSSV) infections, infectious hypodermal and hematopoietic necrosis virus (IHHNV), bacterial infections such as various types of vibrosis, flavobacterium, leucouthrix, zoothamnium infections, fungal infections such as filamentous mycosis, microsporidosis, EMS, AHPND, WSSV, EHP, etc.

In one or more embodiments of the smart aquaculture growth, health and traceability monitoring system, the aquatic species comprises one of fish and shellfish.

In one or more embodiments of the smart aquaculture growth, health and traceability monitoring system, the shellfish comprises one of shrimp and prawn.

In accordance with a broad aspect of the present technology, there is provided a method of operating a smart aquaculture growth, health and traceability monitoring system for measuring the growth, health and providing traceability patterns for aquatic species being grown and harvested. The method comprising using smart phone software application(s) to obtain georeferenced data on the specific aquaculture operation by reading a georeferenced beacon; random sampling of aquatic species by physically capturing an aqueous sample in a container, obtaining at least one digital visual data scan such as a photograph of said sample containing aquatic species, such as shrimp, by using an electronic device such as a smart phone or equivalent device and using the software application to send photographic data to a network for analysis to provide growth, health and traceability data on said aquaculture operation, obtaining results that can be sent back to the smart phone or other computer device to display growth and health parameters and optionally providing recommend courses of action or care directives such as feed rates and water parameter adjustments.

In another embodiment, the method of the present technology provides data access to aquaculture farmers, distributors and customers. Thus, eventual purchasers of a given harvest of aquatic species can monitor growth and health of the harvest and obtain traceability on orders and also place advance orders or purchases for the eventual harvest and its delivery.

In accordance with a broad aspect of the present technology, there is provided a smart aquaculture growth and health monitoring system for monitoring the growth and health of an aquatic species present in an aquaculture growth habitat comprising: a georeferenced location beacon of the growth habitat, a sample container to sample water and aquatic species from the growth habitat and being configured to permit an electronic device having a camera to acquire digital visual data on said sample, a processor communicatively coupled to the electronic device and optionally to a communications network, the processor being operable to: receive the digital visual data, determine, based on the digital visual data growth and/or health parameters of the aquatic species in the sample, wherein the growth and/or health parameters of the aquatic species are determined by graphic measurement, chromatographic or shape analyses.

In one or more embodiments of the smart aquaculture growth and health monitoring system, said processor being further operable to retransmit data on the growth and/or health parameters of the aquatic species back to the electronic device.

In one or more embodiments of the smart aquaculture growth and health monitoring system, said electronic device further receives sensor data from sensors located in or around the growth habitat or in the sample container, said sensors being communicatively coupled to the processor or electronic device, the processor being operable to-receive the sensor data, determine, based on the sensor data water quality data and/or further growth and/or health parameters of the aquatic species in the sample, and retransmit water quality data and/or growth and/or health parameters back to the electronic device.

In one or more embodiments of the smart aquaculture growth and health monitoring system, the processor is operable to determine, based on the visual digital image, an approximate total biomass of the aquatic species in the pond, and wherein the processor is operable to determine the growth curve over time of the aquatic species.

In one or more embodiments of the smart aquaculture growth and health monitoring system, the processor has access to a set of machine learning algorithms (MLAs) having been trained to determine the health and growth parameters based on the digital visual data or sensor data.

In one or more embodiments of the smart aquaculture growth and health monitoring system, the set of machine learning algorithms (MLAs) has been trained to determine provide a growth and health parameters of the aquatic species over time.

In one or more embodiments of the smart aquaculture growth and health monitoring system, the set of machine learning algorithms (MLAs) has further been trained to provide aquaculture directives to a user or equipment so as to ameliorate further growth and health of the aquatic species.

In one or more embodiments of the smart aquaculture growth and health monitoring system, the directives are at least one of: aquatic species feed composition, quantity and rate, dispensing of water quality additives, varying oxygenation rates, dispensing medicines and varying water temperature or aeration of the growth habitat.

In one or more embodiments of the smart aquaculture growth and health monitoring system, processor can be operatively linked to equipment that is activated to implement said directives either automatically or by user input.

In one or more embodiments of the smart aquaculture growth and health monitoring system, said processor further provides aquatic species traceability data and is adapted to retransmit traceability reports on the provenance and aquaculture conditions and feed source in a given growth habitat and for specific aquatic species harvests.

In one or more embodiments of the smart aquaculture growth and health monitoring system, the provenance and aquaculture conditions and feed source include the geographical location of the growth habitat and one or more of the feed manufacturer, production dates, feed ingredients and feeding conditions.

In one or more embodiments of the smart aquaculture growth and health monitoring system, the processor is further operable to transmit, over a communication network, an indication to order supplies or equipment for the maintenance of the growth habitat so as to implement said directives.

In one or more embodiments of the smart aquaculture growth and health monitoring system, the aquatic species comprises one of fish and shellfish.

In one or more embodiments of the smart aquaculture growth and health monitoring system, the shellfish comprises one of shrimp and prawn.

In one or more embodiments of the smart aquaculture growth and health monitoring system, the shellfish is shrimp.

A sample container in accordance of the smart aquaculture growth and health monitoring system wherein the sample container is tubular, open at one end and having a bottom at the other end and adapted to rest and stand on an essentially flat surface, said container being provided with water evacuation holes situated at a predetermined vertical distance from the bottom so as to evacuate excess water from a sample and provided a preset water level, said container being provided with a removable top adapted to receive and hold said electronic device.

In one or more embodiments, the sample container is square.

In accordance with a broad aspect of the present technology, there is provided a method of operating an aquaculture growth habitat to provide growth and health data as well as traceability on provenance and growth conditions on said aquatic species, the method comprising: (a) acquiring georeferenced positioning data of the growth habitat by scanning a position beacon, (b) acquiring a sample of aquatic species in a container, (c) obtaining digital visual data on said aquatic species in said container, (d) causing processing of said digital visual data to obtain a report on growth and health parameters of the aquatic species.

In one or more embodiments of the method, the position beacon comprises a QR code readable by a smart phone.

In one or more embodiments of the method, (c) is performed with a smart phone relaying digital visual data to a processor via a communications network.

A smart portable sampling container for receiving water sampled from an aquaculture grow out pond, the smart portable sampling container comprising: a receptable extending vertically and defining a top opening, the receptacle being sized and shaped for receiving water sampled from the grow out pond, the receptacle comprising: at least one lateral aperture for letting water out, and a compartment for receiving a sensing device comprising a set of sensors for monitoring a water quality of the sampled water in the receptacle, and a lid securable to the top opening of the receptacle, the lid comprising: a camera opening, and a positioning means for positioning an electronic device comprising a camera for acquiring images of an interior of the receptacle.

In one or more embodiments of the smart portable sampling container, the at least one lateral aperture comprises at least two lateral apertures located along a vertical axis, each of the at least two lateral apertures for levelling sampled water from the pond according to an age of an aquatic species.

In one or more embodiments of the smart portable sampling container the receptacle is sized and shaped for receiving between six and sixty shrimps.

In one or more embodiments of the smart portable sampling container, the smart portable sampling container further comprises a bail handle.

### Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, the word “about” when used in relation to numerical designations or ranges means the exact numbers plus or minus experimental measurement errors and plus or minus 10 percent of the exact numbers.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a perspective view of a grow out system in accordance with one or more non-limiting embodiments of the present technology.

FIG. 2A depicts a perspective view of the portable smart sampling device and its inside, the portable smart sampling device for monitoring growth and health of aquatic species and water quality of the grow out system of FIG. 1 in accordance with one or more non-limiting embodiments of the present technology.

FIG. 2B depicts a perspective view of the portable smart sampling device of FIG. 2A with a lid and a client device secured to a receptacle of the portable smart sampling device.

FIG. 2C depicts a top plan view of the inside of the portable smart sampling device of FIG. 2.

FIG. 2D depicts another a top plan view of the portable smart sampling device in accordance with one or more non-limiting embodiments of the present technology.

FIG. 3A depicts a flow chart of a method of using the portable smart sampling device in accordance with one or more non-limiting embodiments of the present technology.

FIG. 3B depicts a flow chart of a method of acquiring images of the inside of the portable smart sampling device in accordance with one or more non-limiting embodiments of the present technology.

FIG. 4A depicts a photograph of a measure of length and weight of a shrimp in accordance with one or more non-limiting embodiments of the present technology.

FIG. 4B depicts an example of a photograph of shrimps located inside the smart sampling device and an example of image recognition of the shrimps performed using one or more machine learning algorithms in accordance with one or more non-limiting embodiments of the present technology.

FIG. 4C depicts growth data and water quality parameters determined using the smart sampling device in accordance with one or more non-limiting embodiments of the present technology.

FIG. 4D depicts further growth data and water quality parameters determined using the smart sampling device in accordance with one or more non-limiting embodiments of the present technology.

FIG. 5 depicts a schematic diagram of an aquaculture communication system in accordance with one or more non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, applications or algorithms, may be represented herein as any combination of flowchart elements or other elements indicating performance of process steps and/or textual or visual description. Such modules may be executed by hardware that is expressly or implicitly shown.

With these fundamentals in place, we will now consider some non-limiting examples to illustrate various implementations of aspects of the present technology.

### Smart Aquaculture Growth, Health and Traceability Monitoring System

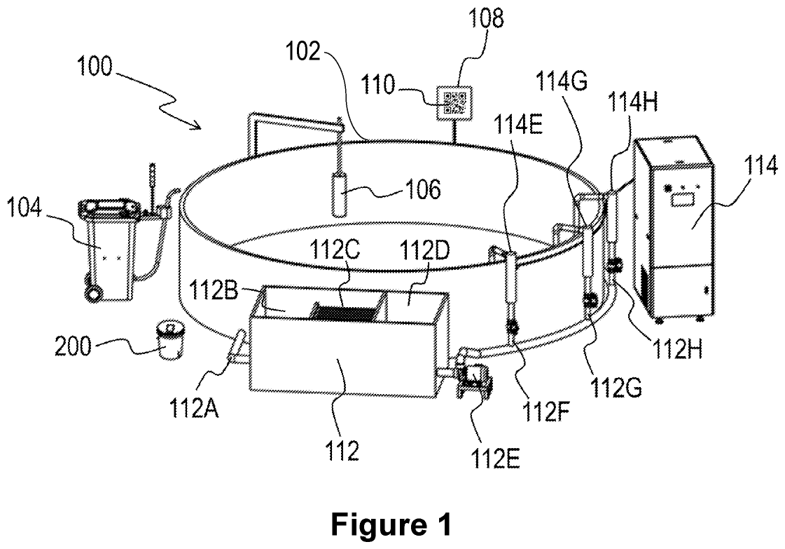

With reference to FIG. 1, there is depicted a perspective view of an aquaculture grow out system 100 in accordance with one or more non-limiting embodiments of the present technology.

The grow out system 100 is used in aquaculture and may be part of an aquaculture farm which may comprise a plurality of grow out systems 100 with aquaculture habitats of various sizes for nursery and grow-out of fishes and shellfishes including shrimp, prawns and the like. Habitats are commonly referred to as ponds 102.

The grow out system 100 comprises inter alia a pond 102, a feeder 104, a set of sensors 106, a water regeneration system 112, an oxygen generation system 114, and a portable smart sampling container 200.

The pond 102 is an aquaculture basin which is sized and shaped to contain water and where larvae of fish, shellfish, shrimp, or prawns are stocked and grown to harvestable size.

The pond 102 has a sign plate 108 comprising a unique georeferenced identifier beacon 110 which may be a scannable code such as a barcode or a QR code. Beacon 110 is used to identify the feeder 104 as well as the location of the grow out system 100, which may be used for traceability purposes as further discussed herein. In one or more alternative embodiments, the beacon 110 may be in the form of a RFID or NFC tag. In one or more other embodiments, the beacon 110 may be a Bluetooth® (e.g., Bluetooth® Low Energy (BLE)) or ultrawideband (UWB) tag.

While pond 102 is illustrated as being in the form of a circular pool, it will be appreciated that the pond 102 may have a different shape or size without departing from the scope of the present technology. As a non-limiting example, the pond 102 have an area of 500 m², 750 m², 1000 m², or 1200 m² and may have a minimum depth of 0.6 m at the shallow end and a maximum depth of 1 m to 2.0 m at the deep end.

The set of sensors 106 are configured to monitor parameters of the grow out system 100 and the aquatic species growing therein including inter alia weather and water quality parameters. The set of sensors 106 comprises inter alia, at least one of a plurality of sensors (not depicted) such as sensors for water or air temperature, dissolved oxygen or carbon dioxide, pH, turbidity, salinity, ammonia level, nitrite level, water hardness, bacteria or fungus levels (microbiology), hydrogen sulfide level or biological oxygen demand (BOD). It will be appreciated that depending on the type of fish or shellfish in pond 102, different parameters may be monitored by the set of sensors 106.

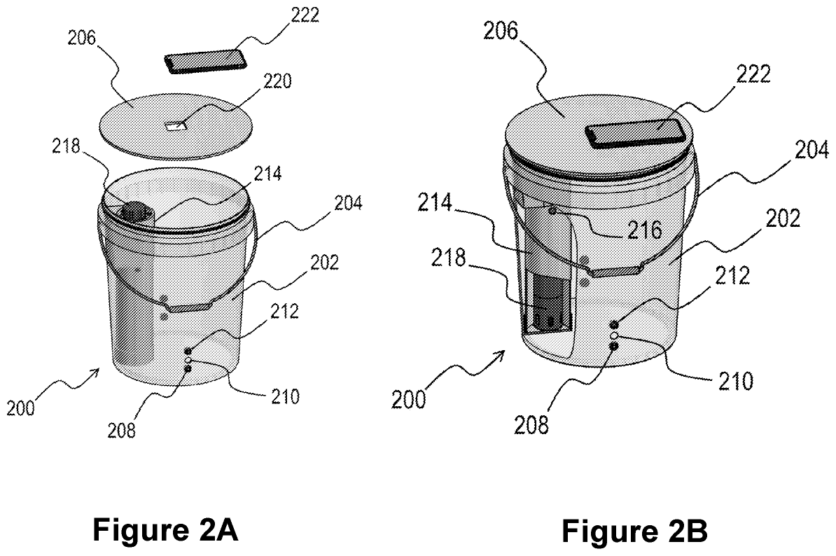

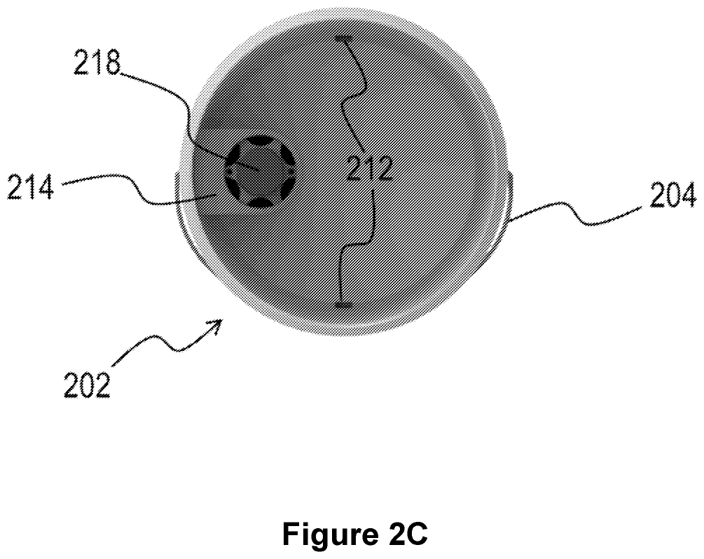

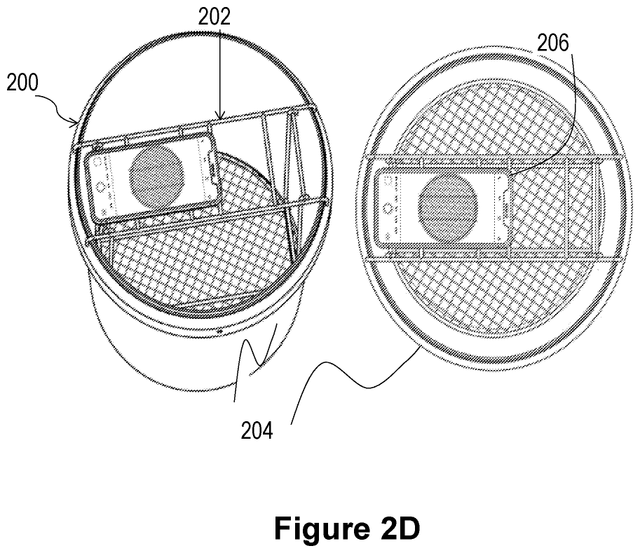

In one or more embodiments, the set of sensors 106 are part of a portable sensing probe (depicted in FIGS. 2A to 2D as portable sensing probe 218), which may be removably securable and which may be adapted to be coupled to one or more different ponds such as the pond 102 and portable sampling containers such as the portable smart sampling container 200. In the illustrated embodiment, the portable sensing device (i.e. the set of sensors 106) is removably secured to a crane (not numbered) and may be lowered into the pond 102. The portable sensing device 106 enables tracking water quality parameters of the pond 102. In one or more embodiments, the portable sensing probe 106 is used to track water quality parameters of different ponds of grow out systems, thus being a more cost-effective solution than having a permanent sensor at each pond. The portable sensing device 106 may thus be coupled to different ponds and smart sampling containers as will be described herein.

The set of sensors 106 comprise or are operatively connected to a communication interface (not depicted in FIG. 1) for transmitting and/or receiving data such as water quality parameters to an electronic device such as a processor or network. It will be appreciated that the set of sensors 106 may transmit sensor data upon receipt of an indication signal, or may transmit the sensor data continuously and/or at predetermined time intervals.

In one or more embodiments, the grow out system 100 may comprise an additional set of sensors for sensing weather and environmental conditions such as a rain gauge sensor, an anemometer and the like and having similar data transmission means.

It will be appreciated that one or more sensors of the set of sensors 106 may be positioned at different locations, such as within the pond 102, adjacent to the pond 102 or may be selectively moved to and removed from the pond 102 by a mechanical system. In one or more embodiments, the set of sensors 106 are part of the portable sensing probe 218 and may be located within a housing (not numbered) thereof.

The feed dispenser 104 is of the kind described in co-pending PCT patent application (PCT/IB2020/057416), the description of which is incorporated herein by reference thereto. In some embodiments, the feeder 104 comprises a controller (not depicted) for activating feed delivery in the aquaculture body of water responsive to inputs from an input/output interface (not depicted) or to inputs from an electronic device which may be directly coupled to the feed dispenser 104 or connected via a communication network (not shown in FIG. 1). In one or more embodiments, the controller of the feeder 104 may also be configured to exchange data with one or more of: the set of sensors 106, the water regeneration system 112, the oxygen generation system 114 and the portable smart sampling container 200.

In one or more embodiments, the grow out system 100 comprises the water regeneration system 112 operatively and fluidly connected with the pond 102 via a water pipe 112A. The water regeneration system 112 comprises three interconnected compartments 112B, 112C, 112D. The first compartment 112B stores water received from the pond 102 via the water pipe 112A. The second compartment 112C comprises water filtration media to separate physically and chemically suspended solids and particulate matter from the water flowing from the pond 102 via the first compartment 112B and allow filtered water to pass through. The filtration media in the second compartment 112C may comprise one or more of sand, gravel, charcoal, anthracite, coconut fibers, and plastic filter mats. The third compartment 112D stores filtered water received from the second compartment 112C. The water regeneration system 112 may further comprise one or more of: aeration systems, water heater, water cooler, chemicals supply subsystems (e.g. salt, potassium permanganate, sumithion, malathion, formalin, bleaching powder, alum, lime, dolomite, gypsum and malachite green) and/or medicine supply subsystem (probiotics, antibiotics, etc.). The water regeneration system 112 further comprises a water pump 112E. The clean water from compartment 112D may be pumped back to the pond 102 via water pipe having one or more water outlets 112F, 112G and 112H.

In one or more embodiments, the oxygen generation system 114 is operatively and fluidly connected to the water regeneration system 112 and the pond 102 via one or more oxygen-water contactors 114F, 114G and 114H. The one or more oxygen-water contactors 114F, 114G and 114H are installed in-line with the water outlets 112F, 112G and 112H to inject high purity oxygen gas from the oxygen generator 114 into the clean water pumped from the compartment 112D to the pond 102. The oxygen generation system 114 separates oxygen (up to 95% purity) from the compressed ambient air containing around 20.5% oxygen, 78% nitrogen, 0.9% argon and 0.6% other gases, through a process called pressure swing adsorption. The pressure swing adsorption process for the generation of enriched oxygen gas from ambient air utilizes the ability of a synthetic molecular sieve, such as X-type zeolite, to absorb mainly nitrogen. While nitrogen molecules are adsorbed by the pore system of the molecular sieve, oxygen gas is produced as a high purity product.

The oxygen generation system 114 uses two towers filled with X-type zeolite as adsorbers. As compressed air passes up through one of the adsorbers, the molecular sieve selectively adsorbs the nitrogen molecules. This process enables the remaining oxygen molecules to pass on up through the adsorber and exit as a high purity oxygen gas. When the adsorber becomes saturated with nitrogen, the inlet airflow is switched to the second adsorber. The first adsorber is regenerated by desorbing nitrogen through depressurisation and purging it with some of the product oxygen. The cycle is then repeated, and the pressure is continually swinging between a higher level at adsorption (production) and a lower level at desorption (regeneration).

In one or more embodiments, the oxygen generator supply system 114 may comprise a controller (not depicted) similar to the controller of the feed dispenser 104, or may have a dedicated controller.

In one or more embodiments, the controller of the water regeneration system 112 is configured to control components (not depicted) of the water regeneration system 112, such as one or more of the water pump, the aeration systems, the water heater, the water cooler, the supply of chemicals (e.g. salt, potassium permanganate, sumithion, malathion, formalin, bleaching powder, alum, lime, dolomite, gypsum and malachite green) or medicines (probiotics, antibiotics, etc.) which enable to control directly or indirectly water quality parameters and/or shellfish or fish health parameters of the grow out system 100.

In one or more embodiments, the controller (not depicted) of the feed dispenser 104 and/or the water regeneration system 112 and/or the oxygen generation system 114 may transmit and receive signals via a wireless or wired communication interface (not depicted) over a communications network (not depicted in FIG. 1). The controller (not depicted) of the feed dispenser 104 and/or the water regeneration system 112 and/or the oxygen generation system 114 may, as a non-limiting example, receive control commands from an electronic device (not depicted) having a processor such as mobile device, to control one or more components of the feeder 104, the water regeneration system 112 and/or the set of sensors 106.

It has been found that useful health and growth parameters of the species in the pond 102 include: size, weight, visual appearance, color, growth rate, appearance of the hepato-pancreatic tract in shrimps or prawns, shell or scale colors, homogeneity of size, and the like which can be determined using inter alia collected by photographic data taken with a mobile device such as a smart phone at various intervals of the growth cycle of the aquatic species using the portable smart sampling container 200. The portable smart sampling container 200 and image analysis method will be described below.

Referring to FIGS. 2A, 2B, 2C and 2D, the portable smart sampling container 200 of the grow out system 100 will now be described. The portable sampling container 200 may be used with one or more grow systems similar to the grow out system 100.

The portable smart sampling container 200 is used for monitoring growth and health of the aquatic species in the pond 102 and for measuring water quality of the pond 102. The portable smart sampling container 200 may be of suitable size and shape to hold a sample of pond water and aquatic species such as shrimp

The portable smart sampling container 200 comprises a receptacle 202 or bucket 202 and a cover or lid 206 securable a top of the receptacle 202. A client device 222 such as a smartphone may be rested on or securable to a top of the lid 206 for acquiring images of the interior of the receptacle 202.

In one or more other embodiments, the client device 222 may be securable to the receptacle 202 instead of the lid 206, as depicted in FIG. 2D.

The receptacle 202 defines a top aperture or opening (not numbered), the receptacle 202 extending vertically and having at least one lateral aperture 208, 210, 212 and a compartment 214 for receiving a smart sensing device 218 comprising the set of sensors 106 (depicted in FIG. 1) for monitoring water quality of water sampled from the pond 102.

The receptacle 202 is depicted in FIGS. 2A to 2D as circular in shape with a handle 204 but could have other shapes such as right-angled tube open at one end and provided with a removable lid 206. As a non-limiting example, the bucket 202 and the lid 206 may be each made of plastic and have an opaque white color. In practice, a random sample is taken from pond 102 by scooping water and pouring the water into the sensor holding tube 214 and plastic bucket 202. The receptacle 202 is set on a flat surface and has the at least one lateral aperture 208, 210 and 212 to let water out. The at least one lateral aperture 208, 210 and 212 act as an automatic water level device and may be located at different vertical positions. In the embodiment depicted in FIGS. 2A and 2B, there are three levels of apertures, where each aperture may be plugged to prevent water from pouring out of the bucket 202 or which may be unplugged to let water out of the bucket 202, depending on the culture age of aquatic species. In case of shrimps, the bottom apertures 208 are used for shrimps younger than 40 culture days, while the middle apertures 210 and top apertures 212 are optionally closed with rubber plugs. The middle apertures 210 are used for shrimps between 40 and 80 culture days, while the bottom apertures 208 and top apertures 212 are closed with rubber plugs. The top apertures 212 are used for shrimps older than 80 culture days, while the bottom apertures 208 and middle apertures 210 are closed with rubber plugs. A sufficient number of aquatic species in the pond 102 are taken by using a net, and then dropped in plastic bucket 202. As a non-limiting example, in the case of shrimps, the sample is preferred to have between 6 and 30 individuals depending on the culture age.

The bucket 202 comprises a sensor compartment 214 or sensor holding tube 214 sized and shaped for receiving the smart sensing device 218 comprising the set of sensors 106. The sensor holding tube 214 is adapted to receive and hold the smart sensing device 218 such that the smart sensing device 218 is immersed at least partially in the sample of pond water present in the bucket 202 thereby enabling the smart sensing probe to measure, via its set of sensors 106, indications of pH, nitrite, salinity, turbidity and water temperature and other water quality parameters of the sample water of the grow out pond 102. The sensor holding tube 214 has a lateral aperture 216 for leveling water and prevent overflow of water in the sensor holding tube 214. It will be appreciated that the sensor holding tube 214 may be replaced by any adequate structure which enables the smart sensing device 218 to acquire water quality parameters of the water in the bucket 202 and secure at least partially the smart sensing device 218 to the bucket 202.

In one or more embodiments, the smart sensing device 218 may be the smart sensing probe comprising the set of sensors 106 of FIG. 1, which may be removed from the pond 102 to be inserted into the sensor holding tube 214. In one or more other embodiments, the smart sensing device 218 may be a different smart sensing probe.

In one or more embodiments, the smart sensing device 218 provides water quality data such as pH, nitrite levels, salinity, turbidity and water temperature to the client device 222 via a communication interface, such as but not limited to Bluetooth® communication interface, which may be uploaded to a server (not depicted in FIGS. 2A-2D) over a communications network such the Internet through a software application 300. It will be appreciated that in one or more alternative embodiments, the data from the smart sensing device 218 may be acquired via a direct wired connection, direct wireless connection, indirect wired connection, indirect wireless connection or a combination thereof without departing from the scope of the present technology.

In practice, after scooping water from the pond 102 and once a predetermined water level is achieved by appropriate water evacuation, a plastic lid 206 is then placed atop the receptacle 202. A client device 222 comprising digital camera such as a smartphone may be positioned with its camera facing down onto a top of the container 200. More specifically, the client device 222 is laid flat on the lid 206 to provide a standardized focal length between the client device 222 and the established water level in the receptacle 202. The lid 206 is of course provided with apertures 220 to provide a clear field of view to the camera of the client device 222. This setup ensures that the images acquired by the client device 222 image characteristics such as length measurements of the aquatic species such as shrimp are consistent so that appropriate calculations or other image analysis can be reliably performed. Indeed the distance between the client device 222 and the predetermined water level enables the camera to have a sufficient field of view to acquire images and/or videos of the inside of the receptacle 202. In one or more other embodiments, the client device 222 may be replaced by a digital camera or any other type of device having imaging means to capture photos of the inside of the receptacle 202.

In one or more embodiments, digital sample images captured by the camera of the client device 222 are transmitted to a processor, a server or other electronic device (not depicted in FIG. 2) for analysis thereof. In one or more alternative embodiments, the analysis of the images may be performed locally by the client device 222. An aquaculture communication system will be described in more detail herein below.

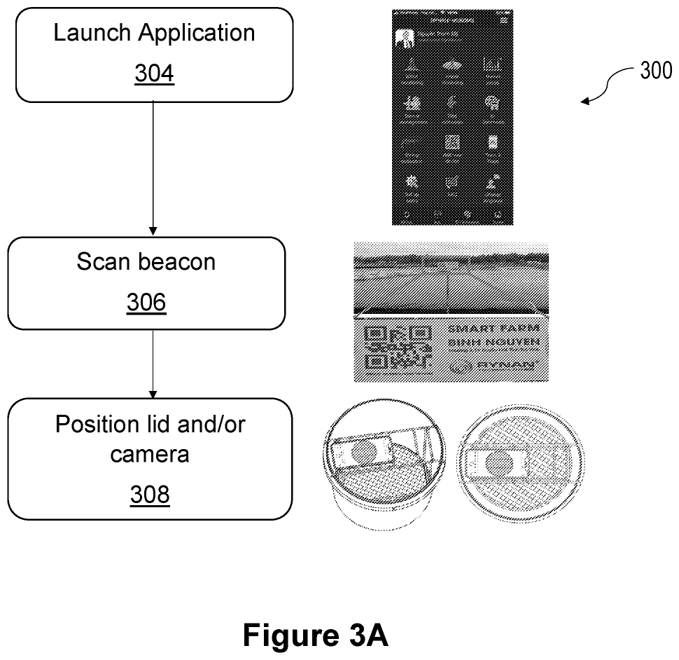

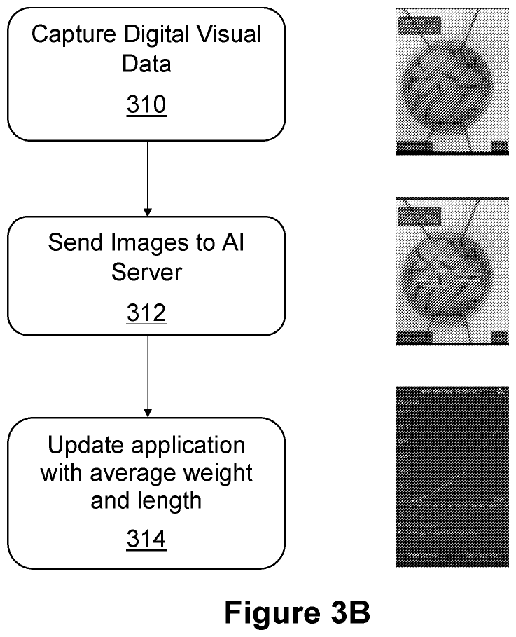

With reference to FIG. 3A, the sampling method starts with launching of the mobile device application 300 (step 304). The sampling method comprises a digital reading of the georeferenced pond 102 by scanning the beacon 110 on the pond identification plate 108 (step 306). In the depicted embodiment, this is done through a software application 300 (step 304) previously downloaded on the client device 222. It will be appreciated that other methods may be used to uniquely identify and/or authenticate the pond 102 via the client device 222. This provides and confirms the geographical location of the pond 102. In one or more embodiments, the client device 222 and the application 300 may also confirm a geographical location by geopositioning software imbedded therein.

Once secured on top of the lid 206 with a sample of water and aquatic species present in the receptacle 202 (step 308), the client device 222 is operable to acquire one or more images of the inside of the bucket 202, as depicted in FIG. 3B (step 310). It will be appreciated that different methods may be used to cause the client device 222 to acquire images, such as a timer, an image detection system, confirmation tags and the like. As a non-limiting example, the client device 222 may be configured to detect it is in place or proximity of a tag in the bucket 202 which may cause acquisition of images.

Further data from the portable sensing device 218 comprising the set of sensors 106 or other sources such as weather, date, wind, etc. are also accessible by the application 300 or a network.

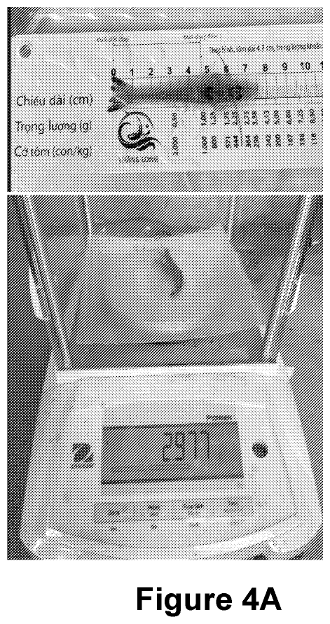

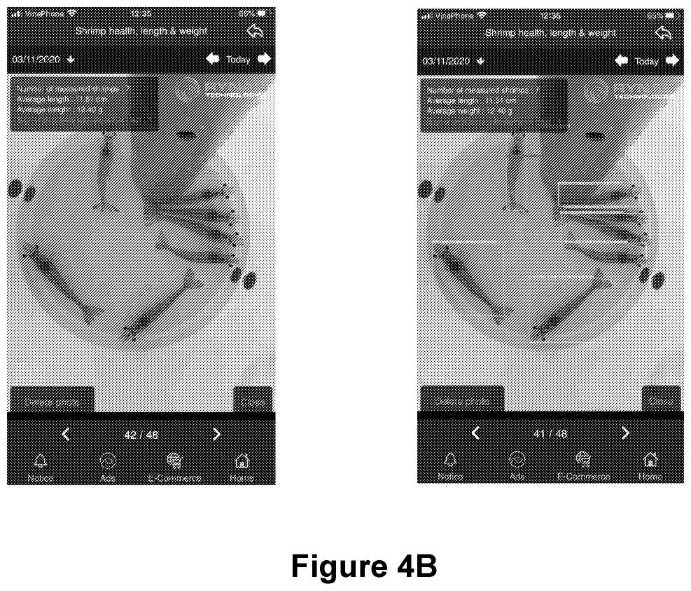

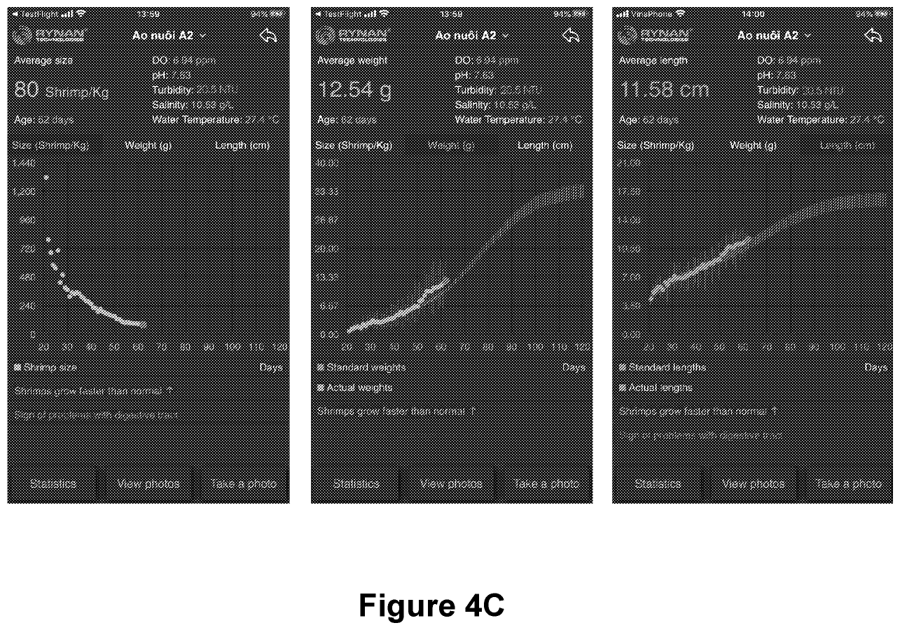

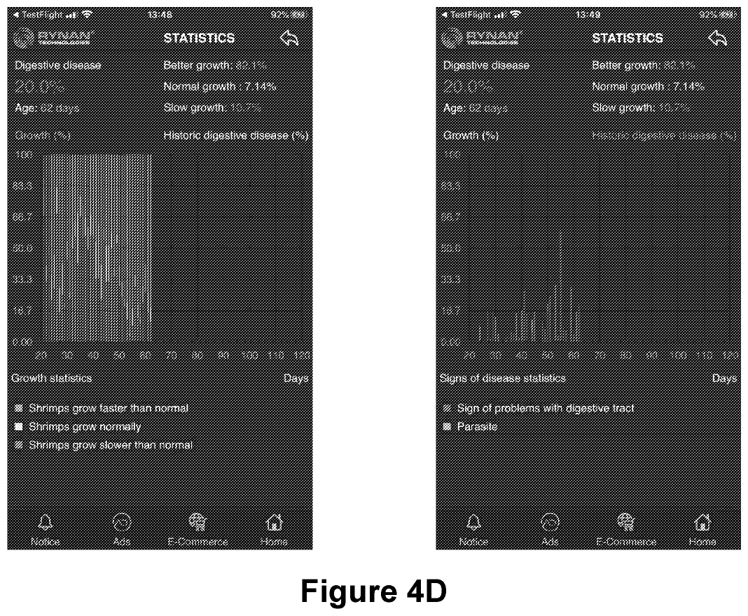

The digital image(s) of the inside of the portable smart sampling container 200 may be stored, transmitted and analyzed (step 312 and step 314) using one or more techniques described in more detail herein below. Images captured by the client device 222 are sent wirelessly to an artificial intelligence network or processed within the application to provide measurements of the aquatic species and to provide color or other image analysis indicative of health or growth parameters (depicted in FIG. 4B-4D).

The application 300 is adapted to provide or receive display information on various health or growth parameters such as the average individual aquatic species weight or length, such as a growth curve of time (depicted in FIG. 4D). In one embodiment, the parameters are provided in real-time.

It will be appreciated that different users may have different privileges and access to different options of software application 300. As a non-limiting example, the first user associated with application 300 may be a worker and may need to authenticate using the application 300.

In one or more embodiments, the application 300 executed by the client device 222 provides weather data, pond parameter data (water quality), fish or shellfish data (identification, counts, size estimation), photographs of the fish or shellfish, the data progression over time with for example daily data for each installation of the network of grow out systems 100 along with their geographical location on a map.

The application 300 can also provide advertising space for product placement. The application 300 can also provide advice and tutorial means for aquaculture of fish and shellfish as well as instant communication means to delegated staff that may answer questions from users such as via chat, direct messaging or email.

In some embodiments, application 300 may also provide recommendations for variation of parameters such as diet, food quantity delivery, chemical or medicine inputs, water temperature, oxygenation, etc. so as to improve the health and favor optimal growth of the aquatic species over time.

More specifically, growth parameters can be extrapolated by the algorithm described below.

### Weight-Length Relationship

In one or more embodiments, the weight-length relationship of an aquatic species may be established by the following equation.

$$W = {qL}^{b} \qquad Equation$$

Find b:
Solution
   Convert the length measurements to ln L (column no. 4) and the weight measurements to ln W (column no. 5).
   Square the ln L (column no. 6) and ln W (column 7).
   Multiply ln L by ln W (column 8).
   Sum in L, ln W, (ln L)², (ln W)², and (ln L)(ln W)
   Find the arithmetic mean for ln L and ln W

| | | | (x) | (y) | (x)² | (y)² | (x)(y) |
|---|---|---|---|---|---|---|---|
| i | L | W | In L | In W | (In L)² | (In W)² | (In L)(In W) |
| 1 | | | | | | | |
| 2 | | | | | | | |
| 3 | | | | | | | |
| . . . | | | | | | | |
| n | | Total Mean | Σx | Σy | Σx² | Σy² | Σxy |

Estimate the slope (b) by means of the relationship

$$b = \frac{\sum xy - \frac{[ ( \sum x ) ( \sum y ) ]}{n}}{\sum {x}^{2} - \frac{{( \sum x )}^{2}}{n}}$$

Find q:
   Transformed into linear functions:

$$ln W = ln q + b * ln L$$

This equation is equivalent the regression equation:

$$y = a + b * x ( with y = ln W ; a = ln q ; x = ln L )$$

$$a = y - b * x$$

$$Get q from a$$

$$a = ln q$$

$$q = {exp}^{a}$$

Regarding to the b value, the following three types of growth were showed:
When b=3, the type of growth is described as isometric, meaning shape does not change as growth occurs.
When b>3, the growth type is positively allometric, the increase in weight occurred at a faster rate than did the increase in carapace length.
When b<3, the growth type is negatively allometric, the increase in weight occurred at a slower rate than did the increase in carapace length.

### Example

Referring to FIG. 4A, in an embodiment, the weight-length relationship is established as follows: to build a database for use by one or more machine learning algorithm(s), individual shrimps are collected and accurately measured in body length and in body weight. This enables populating a database comprising relationships between average length (L) and average body weight (W) for a particular aquatic species.

Upon repeating these steps multiple times, a database may be populated adequately which enables solving the above equation.

| | | | (x) | (y)² | (x)² | (y)² | (x)(y) |
|---|---|---|---|---|---|---|---|
| I | L(cm) | W(g) | In L | In W | (In L)² | (In W)² | (In L)(In W) |
| 1 | 6.9 | 2.2 | 1.932 | 0.788 | 3.73077 | 0.62167 | 1.52292 |
| 2 | 6.4 | 2.2 | 1.856 | 0.788 | 3.44584 | 0.62167 | 1.46361 |
| 3 | 5.8 | 1.7 | 1.758 | 0.531 | 3.09006 | 0.28157 | 0.93277 |
| 4 | 6.5 | 2.2 | 1.872 | 0.788 | 3.50364 | 0.62167 | 1.47584 |
| 5 | 6.5 | 2.3 | 1.872 | 0.833 | 3.50364 | 0.69374 | 1.55904 |
| 6 | 6.7 | 2.4 | 1.902 | 0.875 | 3.61801 | 0.76645 | 1.66524 |
| 7 | 7.1 | 2.7 | 1.960 | 0.993 | 3.84197 | 0.98655 | 1.94687 |
| 8 | 6.8 | 2.3 | 1.917 | 0.833 | 3.67459 | 0.69374 | 1.59662 |
| 9 | 6.7 | 2 | 1.902 | 0.693 | 3.61801 | 0.48045 | 1.31844 |
| 10 | 6.3 | 2.2 | 1.841 | 0.788 | 3.38762 | 0.62167 | 1.45119 |
| 11 | 6.9 | 2.8 | 1.932 | 1.030 | 3.73077 | 1.06012 | 1.98873 |
| 12 | 6.3 | 2.3 | 1.841 | 0.833 | 3.38762 | 0.69374 | 1.53301 |
| 13 | 6.8 | 2.5 | 1.917 | 0.916 | 3.67459 | 0.83959 | 1.75646 |
| 14 | 7.4 | 3.2 | 2.001 | 1.163 | 4.00592 | 1.35292 | 2.32802 |
| 15 | 6.5 | 2.4 | 1.872 | 0.875 | 3.80364 | 0.76645 | 1.63870 |
| 16 | 6.4 | 2.2 | 1.856 | 0.788 | 3.44584 | 0.62167 | 1.46361 |
| 17 | 6.2 | 1.7 | 1.825 | 0.531 | 3.32898 | 0.28157 | 0.96816 |
| 18 | 7.2 | 3.1 | 1.974 | 1.131 | 3.89700 | 1.28007 | 2.23348 |
| 19 | 7.4 | 2.8 | 2.001 | 1.030 | 4.00592 | 1.06012 | 2.06076 |
| 20 | 7.4 | 3.2 | 2.001 | 1.163 | 4.00592 | 1.35292 | 2.32802 |
| 21 | 7.5 | 2.5 | 2.015 | 0.913 | 4.05983 | 0.83959 | 1.84624 |
| 22 | 7.4 | 3.3 | 2.001 | 1.194 | 4.00592 | 1.42545 | 2.38961 |
| 23 | 7.4 | 3.6 | 2.001 | 1.281 | 4.00592 | 1.64079 | 2.56376 |

to . . .

| | | | | | | | |
|---|---|---|---|---|---|---|---|
| 66 | 7 | 3.032 | 1.946 | 1.109 | 3.78657 | 1.23037 | 2.15845 |
| 67 | 7.9 | 3.975 | 2.067 | 1.380 | 4.27192 | 1.90447 | 2.85232 |
| 68 | 8.8 | 5.116 | 2.175 | 1.632 | 4.72955 | 2.66464 | 3.55001 |
| 69 | 7.8 | 3.701 | 2.054 | 1.309 | 4.21942 | 1.71244 | 2.68803 |
| 70 | 7.1 | 3.175 | 1.960 | 1.115 | 3.84197 | 1.33474 | 2.26451 |
| 71 | 7.7 | 3.542 | 2.041 | 1.265 | 4.16658 | 1.59944 | 2.58151 |
| 72 | 7.4 | 3.107 | 2.001 | 1.134 | 4.00592 | 1.28518 | 2.26899 |
| 73 | 8.7 | 5.613 | 2.163 | 1.725 | 4.67997 | 2.97592 | 3.73192 |
| 74 | 7.8 | 4.089 | 2.054 | 1.396 | 4.21942 | 1.94881 | 2.86755 |
| 75 | 7.2 | 3.166 | 1.974 | 1.152 | 3.89700 | 1.32818 | 2.27507 |
| 76 | 7.3 | 2.686 | 1.988 | 0.988 | 3.95164 | 0.97625 | 1.96413 |
| 77 | 7.1 | 3.062 | 1.960 | 1.119 | 3.84197 | 1.25231 | 2.19348 |
| 77 | Total | 248.861000 | 152.69983 | 85.74777 | 303.87413 | 105.19718 | 173.08883 |
| | AVERAGE (In) | 3.231961 | 1.983115 | 1.113607 | | | |
| | | | Σx | Σy | Σx² | Σy² | Σxy |

| Equation | | W = q * L \hat{ } b |
|---|---|---|
| Find b: | | |
| $I = \sum xy - \frac{[ ( \sum x ) ( \sum y ) )}{n}$ | 3.041176 | |
| $J = \sum {x}^{2} - \frac{{( \sum x )}^{2}}{n}$ | 1.05287534 | |
| b = I/J | 2.88844831 | |

| | |
|---|---|
| $b = \frac{\sum xy - \frac{[ ( \sum x ) ( \sum y ) )}{n}}{\sum {x}^{2} - \frac{{( \sum x )}^{2}}{n}}$ | 2.88844831 |

| Find q: | | |
|---|---|---|
| In W=In q+ b*In L | | |
| <=>y=a+b*x | (with y = In W; a = In q; x= In L) | |
| a = y − b*x | <=> a = InW − b*InL= −4.6145167 | |
| a = In q | | |
| q = exp^{a} | = 2.718282\hat{ } −4.61451668 0.00990697 | |
| W= q*LAb= | 0.009907 * L\hat{ } 2.88844831 | |
| Result: | | |
| 10.400 | L | (Length cm) |
| 8.582 | W | (Weight gram) |

Still referring to FIG. 4A to 4D, the digital images collected from sampling can be analyzed with the above equations and algorithm to provide calculated weight of the aquatic species in the sample and other parameters such as average weight and various statistical analyses such as standard deviation, outliers, etc.

Similarly, digital images acquired by the client device 222 can be analyzed for chromatographic or other visual patterns including coloration and shading. For shellfish species such as shrimp, visual data can provide information on internal organ morphology or color, such as the hepato-pancreatic tract which is visible because of the transparency of the shrimp carapace, visual images may also provide various other characteristics indicative of health and growth of the aquatic species. This is similarly done by using one or more machine learning algorithms having been trained therefor based on database relationships between digital images and various health conditions or diseases as described above. FIG. 4B provides an example of such analysis.

The application 300 is connected to a server over a communications network to run the algorithms and to provide on-line and real-time image analysis and results such as growth and health data over time. The application 300 can also be adapted to provided recommendations for health and growth improvement of the aquatic species by providing advice or icon graphical representations of recommended requirements such as adjusting feed type, quantity, water parameters, chemicals, medicines and the like.

It will be appreciated that application 300 may collect data over time and can also be connected to the feeder 104, this provides full traceability of the aquatic species from start to finish of the growth cycle and the harvest.

Application 300 can also feature an e-commerce platform for direct sourcing and ordering of required or recommended equipment or supplies.

### Aquaculture Communication System

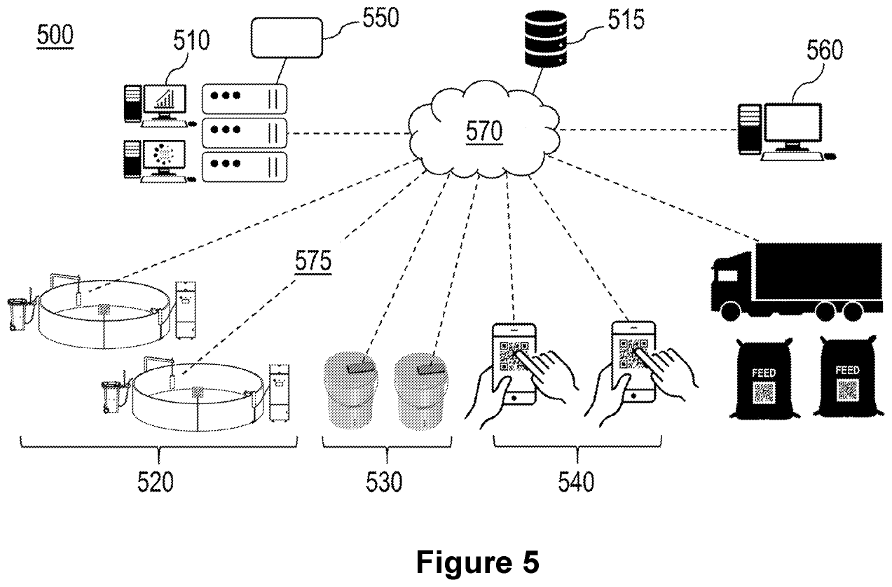

With reference to FIG. 5, there is shown a schematic diagram of an aquaculture communication system 500, the aquaculture communication system 500 being suitable for implementing one or more non-limiting embodiments of the present technology.

The aquaculture communication system 500 comprises inter alia one or more servers 510, a database 515, a plurality of aquaculture grow out systems 520, a plurality of portable smart sampling containers 530, a plurality of client devices 540, and an e-commerce platform 560 communicatively coupled over a communications network 570 via respective communication links 575 (only one numbered in FIG. 3).

The plurality of aquaculture grow out systems 520 comprise one or more aquaculture grow out systems such as the grow out system 100 of FIG. 1. The plurality of smart sampling containers 530 comprise one or more portable smart sampling containers such as the smart sampling container 200 of FIGS. 1 and FIGS. to 2A-2C.

### Server

The server 510 is configured to: (i) receive data from and transmit data to one or more of the plurality of aquaculture grow out systems 520, the plurality of portable smart sampling containers 530, the plurality of client devices 540, and the e-commerce platform 560; (ii) analyze data exchanged between the plurality of aquaculture grow out systems 520, the plurality of portable smart sampling containers 530, the plurality of client devices 540, and the e-commerce platform 560; (iii) access a set of machine learning algorithms (MLAs) 550; (iv) train the set of MLAs 550 to perform analysis and provide recommendations related to the plurality of aquaculture grow out systems 520; and (v) provide recommendations by using the set of MLAs 550.

It will be appreciated that the server 510 can be implemented as a conventional computer server. The server 510 comprises inter alia a processing unit or processor operatively connected to a non-transitory storage medium and one or more input/output devices. The server 510 comprises one or more communication interfaces (not depicted) for establish a respective communication link 575 with the communication network 570.

In a non-limiting example of one or more embodiments of the present technology, the server 510 is implemented as a server running an operating system (OS). Needless to say the server 510 may be implemented in any suitable hardware and/or software and/or firmware or a combination thereof.

### Machine Learning Algorithm (MLA)

The server 510 has access the set of MLAs 550 which includes one or more machine learning algorithms (MLAs).

Once trained, the set of MLAs 550 is configured to or operable to inter alia, for a given grow out system 100 of the plurality of aquaculture grow out systems 520: (i) receive sensor data from the set of sensors 106 including one or more of images, water quality parameters, fish or shellfish health parameters, and weather conditions; (ii) receive digital images of samples of the aquatic species (iii) determine, based on the sensor data and/or digital image data a current condition of the grow out system 100 including water quality and aquatic species growth and health (iii) provide information such as readouts or graph data and recommendations based on the current conditions of the grow out system 100, including aquafeed quantity recommendations and water quality improvement recommendations or requirement for chemicals or medicines; and (iv) optionally transmit commands to the controller 112 for distribution of an optimal quantity of aquafeed in the pond 102 based on the current conditions of the grow out system 100 or for varying other parameters influencing water quality, temperature, oxygenation, etc. It will be appreciated that the aquafeed quantity recommendations may include aquafeed type, aquafeed weight, aquafeed size, and feed schedule.

In one or more embodiments, the set of MLAs 550 is further configured to automatically order products such as aquafeed or chemicals or other supplies or equipment from the e-commerce platform 560 based on the current conditions of the grow out system 100.

The set of MLAs 550 is trained such that health and growth of the aquatic species is monitored and optimized and to minimize human intervention in the growth process in pond 100. The set of MLAs 550 is trained in a semi-supervised or supervised manner to learn correlations and interactions between different water quality parameters, such as but not limited to the DO, temperature, pH, salinity, carbon dioxide (CO₂), ammonia, nitrite, hardness, alkalinity, hydrogen sulfide (H₂S), biological oxygen demand (BOD), as well as the fish or shellfish health parameters such as, but not limited to, biomass, health, size, age, presence of disease, and the like.

To achieve that objective, the set of MLAs 550 undergoes a training routine based on historical data of aquatic species as described above, as well as other known parameters from the literature or input by operators.

It will be appreciated that the training of the set of MLAs 550 may be specific to the aquatic species in the pond 102, as different penaeid species have different growth cycles, feeding behavior, visual appearance, health parameters and the like. Ibis has been reported in the literature by various authors and shrimp species, including pacific white shrimp (Litopenaeus vannamei), pacific blue shrimp (L. stylirostris), black tiger shrimp (Penaeus monodon) and other species. Some species and sizes can exhibit a more aggressive feeding behavior than others, and behavior can also be affected by environmental conditions, time of day/night, availability of natural food, health, size, shrimp density and other variables.

It will be appreciated that for each parameter, animals have a broader range of tolerance and a narrower optimum range that promotes growth, survival and overall well-being. Extreme temperatures (too high or too low) and low dissolved oxygen levels will reduce feeding rates. As a non-limiting example, recommended levels of dissolved oxygen in the industry were accepted at 2.5 to 3.0 ppm, but this level should be at least 4.0 ppm or higher, which can be challenging in semi-intensive culture systems without mechanical aeration.

As a non-limiting example, for Litopenaeus vannamei shrimps, the preferred water quality parameters are: (i) water temperature between 28 and 30° C.; (ii) DO is >4 ppm; (iii) pH is between 7.5 and 8.0; (iv) turbidity is <30NTU; and (v) salinity is >10.0 ppt.

As a non-limiting example, shrimp molt periodically (days to weeks) during their lives, and this is a stressing period during which their appetite diminishes markedly and so do their growth curves. It can take two to five days for normal feeding to resume and growth curves eventually recover, so it is important to recognize when growth curves a temporarily slowed during molting. Such events require a significant reduction in feed consumption (use of feed trays is a good method) and feeding rates should be adjusted accordingly to avoid feed wastage or disease outbreaks.

Thus, the set of MLAs 550 is trained to monitor, recognize and optimize such conditions. The set of MLAs 550 provides recommendations with regard to the water quality parameters and the fish or shellfish health parameters. In one or more embodiments, the set of MLAs 550 may further automatically adjust one or more of the water quality or health parameters (e.g. by providing instructions to the controller 112) or provide recommendations to operators to do so (e.g. by recommending additions of chemicals to the pond 102, or by raising or lowering the temperature of the pond 102.)

In one or more embodiments, the server 510 may execute the set of MLAs 515. In one or more alternative embodiments, the set of MLAs 550 may be executed by another server (not depicted), and the server 510 may access the set of MLAs 550 for training or for use by connecting to the server (not shown) via an API (not depicted), and specify parameters of the set of MLAs 550, transmit data to and/or receive data from the set of MLAs 550, without directly executing the set of MLAs 550.

As a non-limiting example, one or more MLAs of the set of MLAs 550 may be hosted on a cloud service providing a machine learning API.

It will be appreciated that the functionality of the server 510 may be executed in part or completely by other electronic devices such as one or more of the plurality of client devices 540 and the plurality of aquaculture grow out systems 520.

### Database

A database 515 is communicatively coupled to the server 510 via the communications network 570 but, in one or more alternative implementations, the database 515 may be communicatively coupled to the server 510 without departing from the teachings of the present technology. Although the database 515 is illustrated schematically herein as a single entity, it will be appreciated that the database 515 may be configured in a distributed manner, for example, the database 515 may have different components, each component being configured for a particular kind of retrieval therefrom or storage therein.

In one or more embodiments of the present technology, the database 515 is configured to inter alia: (i) store information relative to the plurality of aquaculture grow out systems 520, including location; (ii) store data relative to users of the plurality of client devices 540 (iii) store data including sensor data acquired by sensors of the plurality of smarting sensing probes 530 and the plurality of aquaculture grow out systems 330; and (iv) store parameters of the set of MLAs 550 including training data, training parameters and the like.

As a non-limiting example, the database 515 may store information such as distributed aquafeed quantities, duration and feeding times for traceability purposes.

### Client Devices

The aquaculture communication system 300 comprises the plurality of client devices 540 such as the client device 222 of FIG. 2 implemented as a smartphone, the plurality of client devices 540 being associated respectively with a plurality of users (not depicted). It will be appreciated that each of the plurality of client devices may be implemented as a different type of electronic device, such as a smartphone but could also be portable cameras, tablets, laptops, netbooks, etc. that may be connected to network equipment such as routers, switches, and gateways. The number of the plurality of client devices is not limited.

In one or more embodiments, each of the plurality of client devices has access to the application 300, which as a non-limiting example may be standalone software or accessible via a browser. The application 300 may enable a user associated with one of the plurality of client devices 540 to access parameters of the plurality of aquaculture grow out systems 520 as described herein above.

### E-Commerce Platform

In one or more embodiments, the application 300 may access an e-commerce platform 560.

The e-commerce platform 560 may be hosted on the server 310 or on another server (not depicted). The e-commerce platform 560 may be a website and/or a stand-alone software accessible by users via the plurality of client devices 340. In one or more embodiments, the e-commerce platform 560 is accessible via application 300.

The e-commerce platform 560 provides commercial products such as aquafeed bags 362 for fish and shellfish, and aquaculture products for delivery to operators of the plurality of aquaculture grow out systems 520. The products provided by the e-commerce platform 560 such as aquafeed bags (not depicted) may comprise a unique aquafeed identifier such as a QR code which may be transmitted to each of the plurality of aquaculture grow out systems 520 upon purchase to ensure that purchased aquafeed bags are received at the respective one of the plurality of aquaculture grow out systems 520. In one or more embodiments, the set of MLAs 550 may automatically or semi-automatically (e.g. upon receipt of confirmation from an operator) order products which may be specific to the conditions of each of the plurality of aquaculture grow out system 330.

For traceability, product orders and stored and recorded for later traceability audits or reports. Other traceability features are described in co-pending PCT application, the contents of which are incorporated herein by reference.

Modifications and improvements to the above-described implementations of the present technology may become apparent to those skilled in the art. The foregoing description is intended to be exemplary rather than limiting.

1-23. (canceled)

24. A smart aquaculture growth and health monitoring system for monitoring the growth and health of an aquatic species present in an aquaculture growth habitat comprising:
a georeferenced location beacon of the growth habitat;
a sample container to sample water and aquatic species from the growth habitat and being configured to permit an electronic device having a camera to acquire digital visual data on said sample;
a processor communicatively coupled to the electronic device and optionally to a communications network, the processor being operable to:
receive the digital visual data;
determine, based on the digital visual data, growth and/or health parameters of the aquatic species in the sample, wherein the growth and/or health parameters of the aquatic species are determined by graphic measurement, chromatographic or shape analyses; and
provide aquatic species traceability data, wherein the processor is adapted to retransmit traceability reports on the provenance and aquaculture conditions and feed source in the growth habitat and for specific aquatic species harvests.

25. The smart aquaculture growth and health monitoring system of claim 24 wherein said processor being further operable to retransmit data on the growth and/or health parameters of the aquatic species back to the electronic device.

26. The smart aquaculture growth and health monitoring system of claim 24 wherein said electronic device further receives sensor data from sensors located in or around the growth habitat or in the sample container, said sensors being communicatively coupled to the processor or electronic device, the processor being operable to
receive the sensor data;
determine, based on the sensor data water quality data and/or further growth and/or health parameters of the aquatic species in the sample; and
retransmit water quality data and/or growth and/or health parameters back to the electronic device.

27. The smart aquaculture growth and health monitoring system of claim 24, wherein the processor is operable to determine, based on the visual digit-al image, an approximate total biomass of the aquatic species in the pond; and wherein the processor is operable to determine the growth curve over time of the aquatic species.

28. The smart aquaculture growth and health monitoring system of claim 24, wherein the processor has access to a set of machine learning algorithms (MLAs) having been trained to determine the health and growth parameters based on the digital visual data or sensor data.

29. The smart aquaculture growth and health monitoring system of claim 28, wherein the set of machine learning algorithms (MLAs) has been trained to determine provide a growth and health parameters of the aquatic species over time.

30. The smart aquaculture growth and health monitoring system of claim 29, wherein the set of machine learning algorithms (MLAs) has further been trained to provide aquaculture directives to a user or equipment so as to ameliorate further growth and health of the aquatic species.

31. The smart aquaculture growth and health monitoring system of claim 30 wherein the directives are at least one of: aquatic species feed composition, quantity and rate, dispensing of water quality additives, varying oxygenation rates, dispensing medicines and varying water temperature or aeration of the growth habitat.

32. The smart aquaculture growth and health monitoring system of claim 31 wherein said processor can be operatively linked to equipment that is activated to implement said directives either automatically or by user input.

33. The smart aquaculture growth and health monitoring system of claim 24 wherein the provenance and aquaculture conditions and feed source include the geographical location of the growth habitat and one or more of the feed manufacturer, production dates, feed ingredients and feeding conditions.

34. The smart aquaculture growth and health monitoring system of claim 24, wherein the processor is further operable to transmit, over a communication network, an indication to order supplies or equipment for the maintenance of the growth habitat so as to implement said directives.

35. The smart aquaculture growth and health monitoring system of claim 24, wherein the aquatic species comprises one of fish and shellfish.

36. The smart aquaculture growth and health monitoring system of claim 35, wherein the shellfish comprises one of shrimp and prawn.

37. The smart aquaculture growth and health monitoring system of claim 36, wherein the shellfish is shrimp.

38. The smart aquaculture growth and health monitoring system of claim 24, further comprising a sample container being tubular, open at one end and having a bottom at the other end and adapted to rest and stand on an essentially flat surface, said container being provided with water evacuation holes situated at a predetermined vertical distance from the bottom so as to evacuate excess water from a sample and provided a preset water level, said container being provided with a removable top adapted to receive and hold said electronic device.

39. The smart aquaculture growth and health monitoring system of claim 38, wherein the sample container is square.

40. A method of operating an aquaculture growth habitat to provide growth and health data as well as traceability on provenance and growth conditions on said aquatic species, the method comprising:
(a) acquiring georeferenced positioning data of the growth habitat by scanning a position beacon comprised in the growth habitat;
(b) acquiring a sample of aquatic species in a container;
(c) obtaining digital visual data on said aquatic species in said container;
(d) providing aquatic species traceability data; and
(e) causing processing of said digital visual data to obtain and retransmit a traceability report on growth and health parameters of the aquatic species and on the provenance and aquaculture conditions and feed source in the growth habitat and for specific aquatic species harvests.

41. The method of claim 40, wherein the position beacon comprises a QR code readable by a smart phone.

42. The method of claim 40 wherein (c) is performed with a smart phone relaying digital visual dam to a processor via a communications network.
